(19) United States
(12) Patent Application Publication
(10) Pub. No.: US 2007/0114684 A1
(43) Pub. Date: May 24, 2007

(54) Optical waveguide and optical waveguide manufacturing method

(75) Inventors: Shigemi Ohtsu, Kanagawa (JP); Toshihiko Suzuki, Kanagawa (JP); Kazutoshi Yatsuda, Kanagawa (JP); Akira Fujii, Kanagawa (JP); Keishi Shimizu, Kanagawa (JP); Eiichi Akutsu, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/472,456

(22) Filed: Jun. 22, 2006

(30) Foreign Application Priority Data
Nov. 21, 2005 (JP) 2005-336283
Nov. 21, 2005 (JP) 2005-336284

(51) Int. Cl. B29D 11/00

(52) U.S. Cl. 264/1.24

(57) ABSTRACT

The present invention provides an optical waveguide manufacturing method. A polymer resin with different refractive index from the polymer film is applied to a polymer film and is cured, so that a double-layered polymer film, which has a cladding layer and a core layer with higher refractive index than the cladding layer, is manufactured. The core layer is cut by the dicing saw having a blade for enabling cutting of a resin layer, so as to be processed into core portions of the optical waveguide. Cut concave portions of the core layer are filled with polymer resin having the same refractive index with the cladding layer. The core portions are further covered with the polymer resin, and the polymer resin is cured so that a cladding resin layer is formed.

### CROSS-REFERENCE TO RELATED APPLICATION

This application claims priority under 35USC119 from Japanese Patent Applications No. 2005-336283 and No. 2005-336284, the disclosures of which are incorporated by reference herein.

### BACKGROUND

1. Technical Field

The present invention relates to a method of manufacturing an optical waveguide for guiding light to be utilized for a mobile device or the like as waveguide light, and an optical waveguide manufactured by this method.

2. Related Art

There are methods, in which resins are laminated and resin layers are processed, for manufacturing an optical waveguide.

According to these methods, high-performance optical waveguides can be manufactured easily.

According to this manufacturing method, however, the polymer resin to be the cladding layer is applied to the substrate, and the polymer resin to be the core layer is applied to the cladding layer so that a double-layered resin layer is formed.

For this reason, the substrate which does not function as the optical waveguide is necessary at the manufacturing steps, and thus the manufactured waveguide is an expensive product.

In the case where a power supply to a mobile device or the like is necessary, an electric conductive line is necessary independently from the optical waveguide.

### SUMMARY

The present invention has been made in view of the above circumstances and provides an optical waveguide and an optical waveguide manufacturing method.

According to an aspect of the present invention, an optical waveguide manufacturing method is provided. The optical wave guide manufacturing method includes: (a) preparing a polymer film, applying polymer resin with refractive index different from the polymer film to the polymer film and curing the resin, so as to manufacture a double-layered polymer film having a cladding layer and a core layer with refractive index higher than the cladding layer; (b) cutting the core layer using a dicing saw with a blade for enabling cutting of the resin layer so as to process the core layer into core portions of an optical waveguide; and (c) filling concave portions of the cut core layer with polymer resin with the same refractive index as the cladding layer, covering the core portions with the polymer resin, and curing the polymer resin so as to form a cladding resin layer.

### BRIEF DESCRIPTION OF THE DRAWINGS

Embodiments of the present invention will be described in detail based on the following figures, wherein:

FIG. 1A is a conceptual diagram illustrating the step of manufacturing a double-layered polymer film in a manufacturing method according to a first exemplary embodiment of the present invention;

FIG. 1B is a conceptual diagram illustrating the step of processing the double-layered polymer film using a dicing saw in the manufacturing method according to the first exemplary embodiment of the present invention;

FIG. 1C is a conceptual diagram illustrating the step of applying resin to the double-layered polymer film processed by the dicing saw in the manufacturing method according to the first exemplary embodiment of the present invention;

FIG. 1D is a conceptual diagram illustrating the step of irradiating the resin applied to the double-layered polymer film with an UV ray in the manufacturing method according to the first exemplary embodiment of the present invention;

FIG. 2 is a perspective view of a multi-blade to be used in the manufacturing method according to the first exemplary embodiment and a second exemplary embodiment of the present invention;

FIG. 3A is a conceptual diagram illustrating the step of manufacturing a triple-layered polymer film in the manufacturing method according to the second exemplary embodiment of the present invention;

FIG. 3B is a conceptual diagram illustrating the step of processing the triple-layered polymer film using a dicing saw in the manufacturing method according to the second exemplary embodiment of the present invention;

FIG. 3C is a conceptual diagram illustrating the step of applying resin to the triple-layered polymer film processed by the dicing saw in the manufacturing method according to the second exemplary embodiment of the present invention;

FIG. 3D is a conceptual diagram illustrating the step of irradiating the resin applied to the triple-layered polymer film with a UV ray in the manufacturing method according to the second exemplary embodiment of the present invention;

FIG. 4A is a conceptual diagram illustrating the step of manufacturing a double-layered polymer film in the manufacturing method according to a third exemplary embodiment of the present invention;

FIG. 4B is a conceptual diagram illustrating the step of processing the double-layered polymer film with a dicing saw in the manufacturing method according to the third exemplary embodiment of the present invention;

FIG. 4C is a conceptual diagram illustrating the step of arranging an electric conductive line in the manufacturing method according to the third exemplary embodiment of the present invention;

FIG. 4D is a conceptual diagram illustrating the step of applying resin to the double-layered polymer film processed by the dicing saw in the manufacturing method according to the third exemplary embodiment of the present invention;

FIG. 4E is a conceptual diagram illustrating the step of irradiating the resin applied to the double-layered polymer film with an UV ray in the manufacturing method according to the third exemplary embodiment of the present invention;

FIG. 5 is a perspective view of a multi-blade to be used in the manufacturing method according to the third exemplary embodiment of the present invention;

FIG. 6A is a conceptual diagram illustrating the step of manufacturing the double-layered polymer film in the manufacturing method according to a fourth exemplary embodiment of the present invention;

FIG. 6B is a conceptual diagram illustrating the step of processing the double-layered polymer film using a dicing saw in the manufacturing method according to the fourth exemplary embodiment of the present invention;

FIG. 6C is a conceptual diagram illustrating the step of applying resin to the double-layered polymer film processed by the dicing saw in the manufacturing method according to the fourth exemplary embodiment of the present invention;

FIG. 6D is a conceptual diagram illustrating the step of laminating a polymer film with electric conductive line in the manufacturing method according to the fourth exemplary embodiment of the present invention;

FIG. 6E is a conceptual diagram illustrating the step of irradiating the resin applied to the double-layered polymer film with an UV ray in the manufacturing method according to the fourth exemplary embodiment of the present invention;

FIG. 7 is a sectional view of the polymer film with electric conductive line to be used in the manufacturing method according to the fourth exemplary embodiment of the present invention;

FIG. 8 is a plan view of an optical waveguide manufactured by the manufacturing method according to the fourth exemplary embodiment of the present invention;

FIG. 9A is a conceptual diagram illustrating the step of manufacturing a triple-layered polymer film in the manufacturing method according to a fifth exemplary embodiment of the present invention;

FIG. 9B is a conceptual diagram illustrating the step of processing the triple-layered polymer film using a dicing saw in the manufacturing method according to the fifth exemplary embodiment of the present invention;

FIG. 9C is a conceptual diagram illustrating the step of arranging electric conductive lines in the manufacturing method according to the fifth exemplary embodiment of the present invention;

FIG. 9D is a conceptual diagram illustrating the step of applying resin to the triple-layered polymer film processed by the dicing saw in the manufacturing method according to the fifth exemplary embodiment of the present invention;

FIG. 9E is a conceptual diagram illustrating the step of irradiating the resin applied to the triple-layered polymer film with an UV ray in the manufacturing method according to the fifth exemplary embodiment of the present invention;

FIG. 10A is a conceptual diagram illustrating the step of manufacturing the triple-layered polymer film in the manufacturing method according to a sixth exemplary embodiment of the present invention;

FIG. 10B is a conceptual diagram illustrating the step of processing the triple-layered polymer film using a dicing saw in the manufacturing method according to the sixth exemplary embodiment of the present invention;

FIG. 10C is a conceptual diagram illustrating the step of applying resin to the triple-layered polymer film processed by the dicing saw in the manufacturing method according to the sixth exemplary embodiment of the present invention;

FIG. 10D is a conceptual diagram illustrating the step of laminating a polymer film with electric conductive line in the manufacturing method according to the sixth exemplary embodiment of the present invention; and

FIG. 10E is a conceptual diagram illustrating the step of irradiating the resin applied to the triple-layered polymer film with an UV ray in the manufacturing method according to the sixth exemplary embodiment of the present invention.

### DETAILED DESCRIPTION

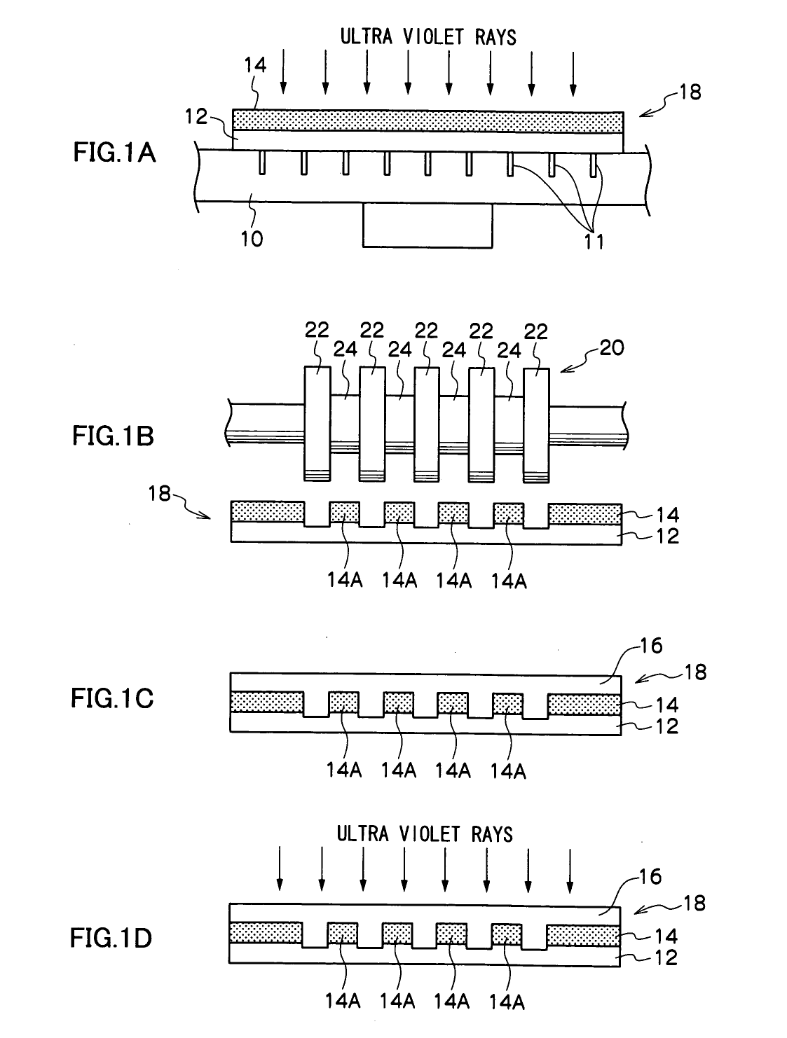

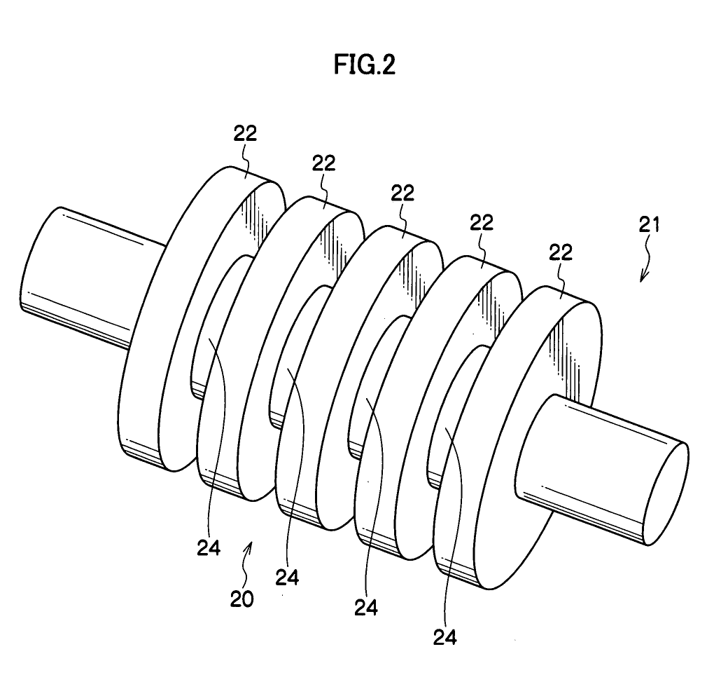

A manufacturing method for an optical waveguide according to a first embodiment of the present invention is explained below following the order of the steps with reference to FIGS. 1A to 2.

As shown in FIG. 1A, a plurality of adsorption ports 11 are formed on the surface of a fixing table 10, and a suction power is generated by a vacuum pump. A polymer film 12 to be a cladding layer is adsorbed and stuck to the fixing table 10, and ultraviolet curing polymer resin with high refractive index is applied uniformly (spin-coating) to the polymer film 12. The polymer resin is irradiated with an UV ray by an UV ray irradiation device so as to be cured, and a core layer 14 and the polymer film 12 are formed so that a double-layered polymer film 18 is manufactured.

For example, a material, in which the refractive index of the core layer 14 is 1.51 and a difference in the refractive index between the core layer 14 and the cladding layer is 0.01 to 0.2, is selected. Various films such as an alicyclic olefin film, an acrylic film, an epoxy film and a polyimide film can be used, but since particularly the layer with high refractive index becomes core portions 14A of an optical waveguide, the light transmittance should be high. Since a layer with low refractive index serves as the cladding layer, even the layer with inferior light transmittance to the layer with high refractive index can be utilized.

It is preferable that the thickness of the double-layered polymer film 18 falls within a range of 70 μm to 200 μm in order to heighten following-up property of the optical waveguide with respect to deformation. Further, due to the similar reason, it is preferable that the width of the double-layered polymer film 18 falls within a range of 0.5 mm to 10 mm, and more preferably a range of 1 mm to 5 mm.

At the next step, as shown in FIG. 1B, the core layer 14 of the double-layered polymer film 18 is cut by a dicing saw 21 having a multi-blade 20 shown in FIG. 2.

As shown in FIG. 2, the multi-blade 20 is composed of two kinds of blades with different outer diameters, blades 24 with small outer diameter are provided between blades 22 with large outer diameter, respectively.

When the core layer 14 is cut by the multi-blade 20, it is divided by the blades 22 with large outer diameter, and the surfaces of the divided core layers are cut by the blades 24 with small outer diameter. In such a manner, a plurality of core portions 14A of the optical waveguide are processed.

For example, in order to form the plural core portions 14A with width of 50 μm and pitch of 250 μm, the blades 22 with large outer diameter with thickness of 50 μm and the blades 24 with small outer diameter with thickness of 200 μm are combined alternately. As a result, the core portions 14A can be processed.

At the next step, as shown in FIG. 1C, concave portions of the core layer 14 cut by the dicing saw 21 (see FIG. 2) are filled with ultraviolet curing polymer resin by the spin-coating method. The core portion 14A is coated with the polymer resin so that a cladding resin layer 16 is formed.

At the next step, as shown in FIG. 1D, the cladding resin layer 16 is cured by UV irradiation using the UV irradiation device.

The double-layered polymer film 18 is, therefore, formed without using a substrate, and the optical waveguide can be manufactured by the inexpensive double-layered polymer film 18.

In the manufacturing method according to the first exemplary embodiment, the polymer film 12 to be the cladding layer is fixed to the fixing table, and the polymer resin to be the core layer 14 with higher refractive index than the polymer film 12 is applied to the polymer film 12 and is cured, so that the double-layered polymer film is manufactured. Instead of this method, the polymer film is fixed to be the core layer 14 to the fixing table, and polymer resin to be a cladding layer with lower refractive index is applied to the core layer and is cured and the double-layered polymer film may be manufactured. In this case, when the double-layered polymer film is manufactured, the core layer is provided on the lower side. For this reason, the double-layered film is turned upside down so that the core layer is arranged on the upper side, and it should be cut by the dicing saw. In this case, for example, an alicyclic olefin film whose refractive index is 1.51 may be used as the core layer, and a fluorinated acrylic resin with low refractive index may be used as the cladding layer.

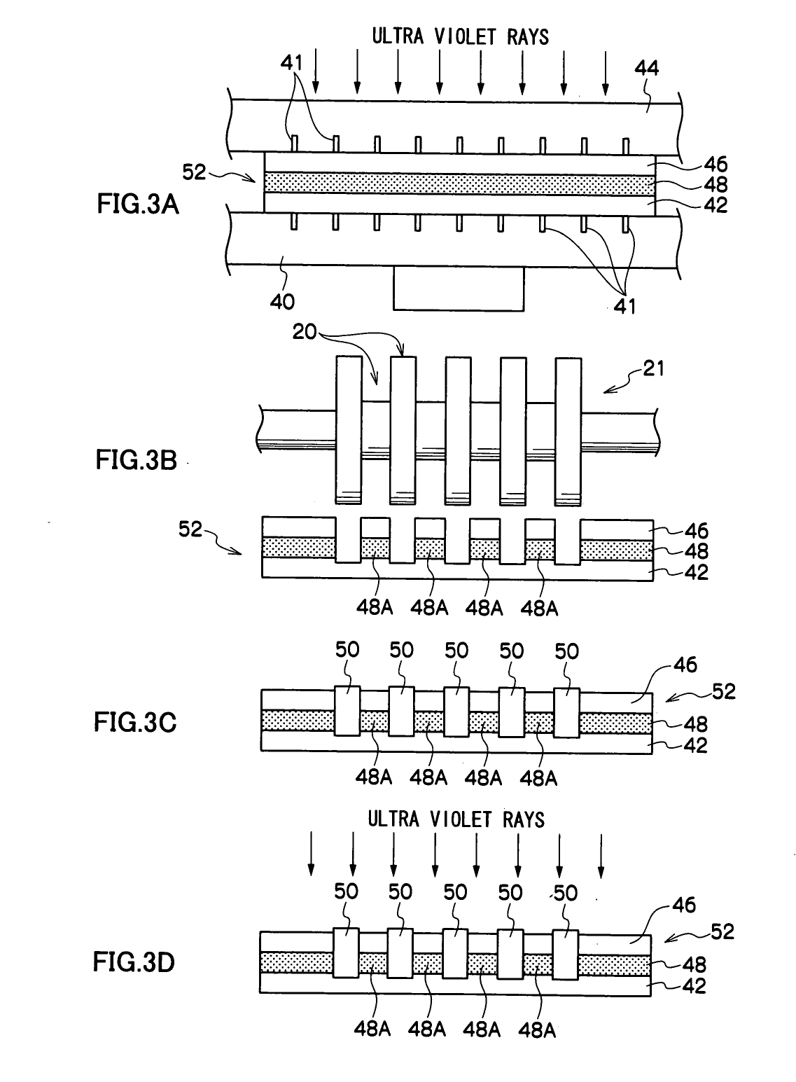

An optical waveguide manufacturing method according to a second exemplary embodiment of the present invention is explained below following the steps with reference to FIGS. 3A to 3D.

As shown in FIG. 3A, a plurality of adsorption ports 41 are formed on a fixing table 40 and the surface of another fixing table 44, and a suction force is generated by a vacuum pump. A first polymer film 42 to be a first cladding layer is adsorbed and stuck to the fixing table 40, so as to be fixed. A second polymer film 46 to be a second cladding layer which is the same material as the first polymer film 42 is adsorbed and stuck to the other fixing table 44 so as to be fixed. Further, an ultraviolet curing polymer resin with higher refractive index than the first polymer film 42 is uniformly applied to the first polymer film 42, and the second polymer film 46 is overlapped with it and is irradiated with an UV ray by the UV ray irradiation device so as to be cured. As a result, a core layer 48 is formed, and a triple-layered polymer film 52 is manufactured.

At the next step, as shown in FIG. 3B, the second polymer film 46 and the core layer 48 are cut by the dicing saw 21 having the multi-blade 20 (see FIG. 2) which is used in the manufacturing method of the first exemplary embodiment. As a result, the core layer 48 is divided, so that a plurality of core portions 48A of the optical waveguide are processed.

At the next step, as shown in FIG. 3C, concave portions of the second polymer film 46 and the core layer 48 cut by the dicing saw 21 are filled with the UV curing polymer resin having the same refractive index as that of the second polymer film 46. As a result, a cladding resin layer 50 is formed, and all the core portions 48A are covered with the polymer resin with the same refractive index.

At the next step, as shown in FIG. 3D, the cladding resin layer 50 is irradiated with an UV ray by the UV ray irradiation device so as to be cured.

In the manufacturing method according to the second exemplary embodiment, the first polymer film 42 to be the first cladding layer and the second polymer film 46 to be the second cladding layer are fixed to the fixing table 40 and the fixing table 44, respectively. Further, the UV curing polymer resin with higher refractive index than the first polymer film 42 is uniformly applied to the first polymer film 42. The second polymer film 46 is overlapped with the first polymer film 42 and is irradiated with an UV ray so as to be cured. As a result, the core layer 48 is formed, and the triple-layered polymer film 52 is manufactured. Instead of this, however, the UV curing polymer resin to be the cladding layer with lower refractive index than the core layer is uniformly applied to both the surfaces of the polymer film to be the core layer and is irradiated with an UV ray so as to be cured. In such a manner, the triple-layered polymer film may be manufactured.

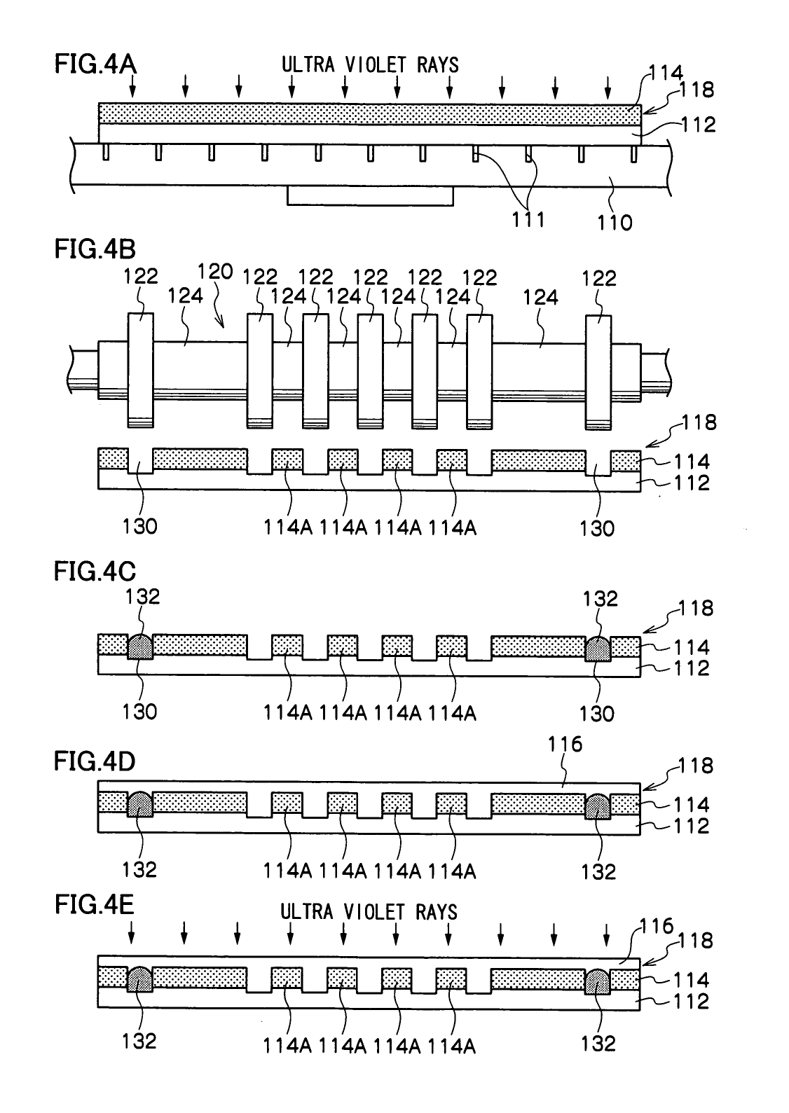

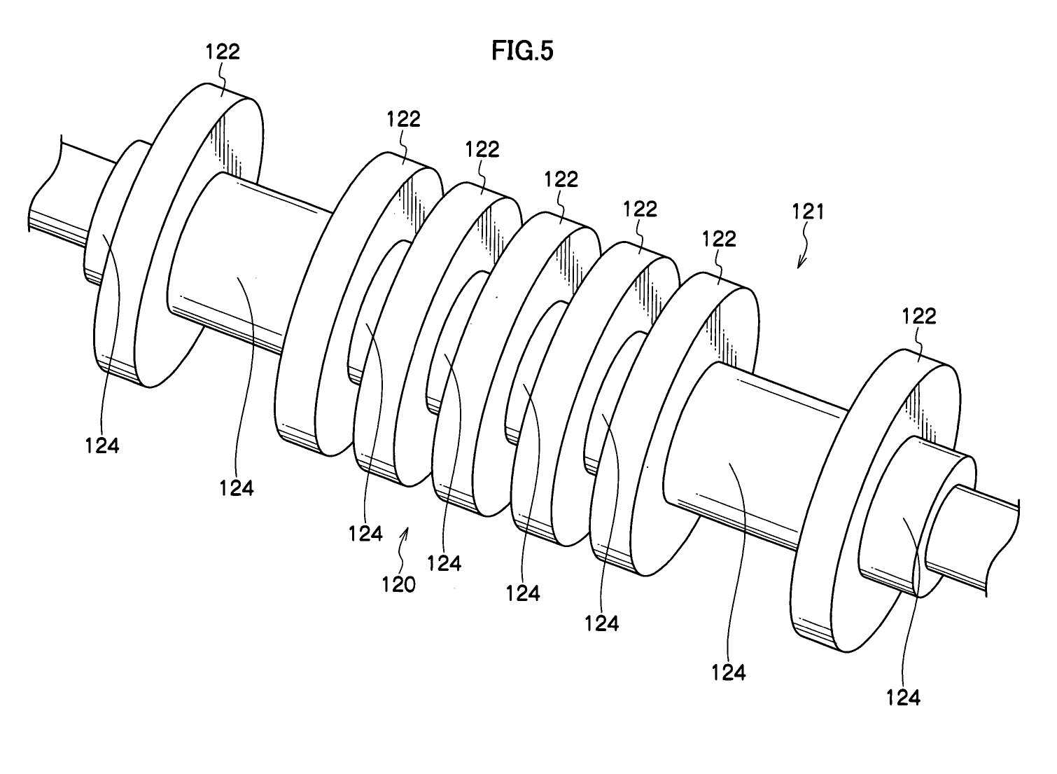

An optical waveguide manufacturing method according to a third exemplary embodiment of the present invention is explained below following the steps with reference to FIGS. 4A to 5.

As shown in FIG. 4A, a plurality of adsorption ports 111 are formed on the surface of a fixing table 110, and a suction force is generated by a vacuum pump. A polymer film 112 to be a cladding layer is adsorbed and stuck to the fixing table 110, a UV curing polymer resin with high refractive index is uniformly applied (spin-coating) to the polymer film 112, and is irradiated with an UV ray by the UV irradiation device so as to be cured. As a result, a core layer 114 and the polymer film 112 are formed, and a double-layered polymer film 118 is manufactured.

For example, a material in which the refractive index of the core layer 114 is 1.51 and a difference in the refractive index between the core layer 114 and the cladding layer is 0.01 to 0.2, is selected. Various films such as an alicyclic olefin film, an acrylic film, an epoxy film and a polyimide film can be used, but since particularly the layer with high refractive index becomes core portions 114A of the optical waveguide, the light transmittance should be high. Since a layer with low refractive index serves as the cladding layer, even the layer with lower light transmittance than the layer with high refractive index can be utilized.

It is preferable that the thickness of the double-layered polymer film 118 falls within a range of 70 μm to 200 μm in order to heighten following-up property of the optical waveguide with respect to deformation. Further, due to the similar reason, it is preferable that the width of the double-layered polymer film 118 falls within a range of 0.5 mm to 10 mm, and more preferably a range of 1 mm to 5 mm.

At the next step, as shown in FIG. 4B, the core layer 114 of the double-layered polymer film 118 is cut by the dicing saw 21 having the multi-blade 120 shown in FIG. 5.

As shown in FIG. 5, the multi-blade 120 is composed of two kinds of blades with different outer diameters, and blades 124 with small outer diameter are provided between blades 122 with large outer diameter, respectively.

When the core layer 114 is cut by the multi-blade 120, the core layer 114 is divided by the blades 122 with large outer diameter, and the surfaces of the divided core layer 114 is cut by the blades 124 with small outer diameter. As a result, a plurality of core portions 114A of the optical waveguide are processed. Further, simultaneously with the processing of the core portions 114A, the core layer 114 is cut by the blades 122 with large outer diameter, and disposing portions 130 for disposing electric conductive lines for power supply are processed at both ends of the core layer 114, respectively, so as to sandwich the core portions 114A.

For example, in order to form the plural core portions 114A with width of 50 μm and pitch of 250 μm, the blades 122 with large outer diameter with thickness of 50 μm and the blades 124 with small outer diameter with thickness of 200 μm are combined alternately. As a result, the core portions 114A can be processed.

At the next step, as shown in FIG. 4C, an electric conductive member is adhered to the disposing portion 130 so that electric conductive lines 132 for power supply are disposed, respectively. For example, the electric conductive lines 132 can be made of a material containing at least one kind selected from copper, iron, nickel, gold, aluminum, silver and their alloy. Further, the electric conductive lines 132 can be manufactured by applying a paste containing silver fine particles using a dispenser. The diameter of the electric conductive lines 132 can be smaller than the diameter of the core portions 114A and can fall within a range of 3 μm to 200 μm.

At the next step, as shown in FIG. 4D, concave portions of the core layer 114 cut by the dicing saw 21 (see FIG. 5) and the disposing portions 130 are filled with ultraviolet curing polymer resin having the same refractive index as the cladding layer by the spin-coating method. The core portions 114A are coated with the polymer resin so that a cladding resin layer 116 is formed.

At the next step, as shown in FIG. 4E, the cladding resin layer 116 is cured by UV ray irradiation using the UV ray irradiation device.

The double-layered polymer film 118 is, therefore, formed without using a substrate, and the inexpensive optical waveguide having the electric conductive lines 132 for power supply can be manufactured by the inexpensive double-layered polymer film 118.

In the manufacturing method according to the third exemplary embodiment, the polymer film 112 to be the cladding layer is fixed to the fixing table, and the polymer resin to be the core layer 114 with higher refractive index than the polymer film 112 is applied to the polymer film 112 and is cured, so that the double-layered polymer film is manufactured. Instead of this method, however, the polymer film to be the core layer is fixed to the fixing table, and polymer resin to be a cladding layer with lower refractive index than the core layer is applied to the core layer and is cured. In such a manner, the double-layered polymer film may be manufactured. In this case, when the double-layered polymer film is manufactured, the core layer is provided on the lower side. For this reason, the double-layered film is turned upside down so that the core layer is arranged on the upper side, and it should be cut by the dicing saw. In this case, for example, an alicyclic olefin film whose refractive index is 1.51 may be used as the core layer, and a fluorinated acrylic resin with low refractive index may be used as the cladding layer.

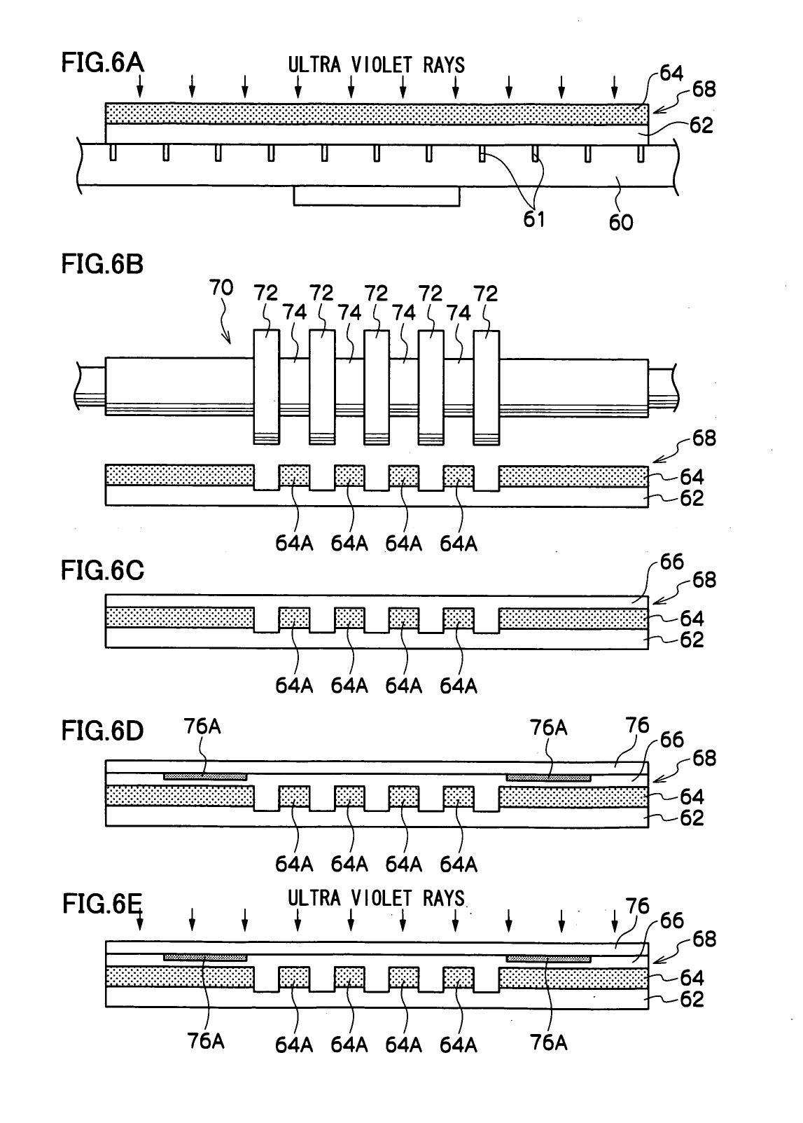

An optical waveguide manufacturing method according to a fourth exemplary embodiment of the present invention is explained below following the steps with reference to FIGS. 6A to 8.

As shown in FIG. 6A, a plurality of adsorption ports 61 are formed on the surface of a fixing table 60, and a suction power is generated by a vacuum pump. A polymer film 62 to be a cladding layer is adsorbed and stuck to the fixing table 60, and ultraviolet curing polymer resin with high refractive index is applied to the polymer film 62. The polymer resin is irradiated with an UV ray by a UV ray irradiation device so as to be cured, and a core layer 64 and the polymer film 62 are formed so that a double-layered polymer film 68 is manufactured.

For example, a material, in which the refractive index of the core layer 64 is 1.51 and a difference in the refractive index between the core layer 64 and the cladding layer is 0.01 to 0.2, is selected. Various films such as an alicyclic olefin film, an acrylic film, an epoxy film and a polyimide film can be used, but since particularly the layer with high refractive index becomes a core portion 64A of an optical waveguide, the light transmittance should be high. Since a layer with low refractive index serves as the cladding layer, even the layer with light transmittance inferior to the layer with high refractive index can be utilized.

It is preferable that the thickness of the double-layered polymer film 68 falls within a range of 70 μm to 200 μm in order to heighten following-up property of the optical waveguide with respect to deformation. Further, due to the similar reason, it is preferable that the width of the double-layered polymer film 68 falls within a range of 0.5 mm to 10 mm, and more preferably a range of 1 mm to 5 mm.

At the next step, as shown in FIG. 6B, the core layer 64 of the double-layered polymer film 68 is cut by a dicing saw having a multi-blade 70.

The multi-blade 70 is composed of two kinds of blades with different outer diameters, blades 74 with small outer diameter are provided between blades 72 with large outer diameter, respectively.

When the core layer 64 is cut by the multi-blade 70, it is divided by the blades 72 with large outer diameter, and the surfaces of the divided core layer 64 are cut by the blades 74 with small outer diameter. In such a manner, a plurality of core portions 64A of the optical waveguide are processed.

For example, in order to form the plural core portions 64A with width of 50 μm and pitch of 250 μm, the blades 72 having large outer diameter and thickness of 50 μm, and the blades 74 having small outer diameter and thickness of 200 μm are combined alternately. As a result, the core portions 64A can be processed.

At the next step, as shown in FIG. 6C, concave portions of the cut core layer 64 are filled with ultraviolet curing polymer resin with the same refractive index with the cladding layer by the spin-coating method. The core portions 64A are coated with the polymer resin so that a cladding resin layer 66 is formed.

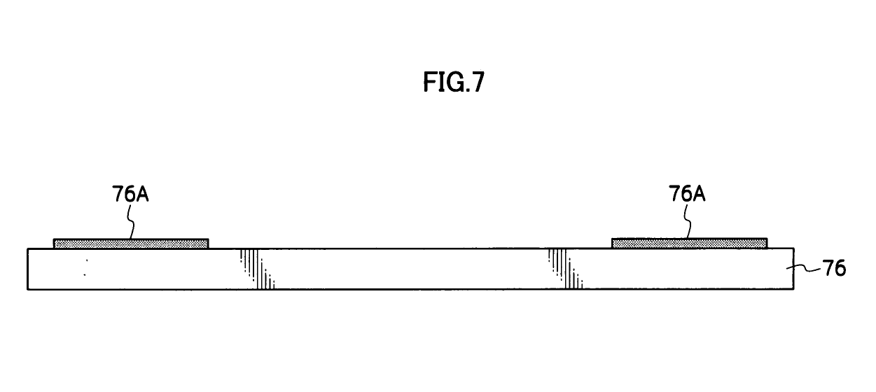

At the next step, as shown in FIG. 6D, a pair of electric conductive lines 76A for power supply shown in FIG. 7 are provided to the cladding resin layer 66, and a polymer film 76 with electric conductive line whose refractive index is the same as the cladding layer is laminated to the cladding resin layer 66. For example, the electric conductive lines 76A can be made of a material containing at least one kind selected from a copper, iron, nickel, gold, aluminum, silver and their alloy. Further, the electric conductive lines 76A can be manufactured by applying paste containing silver fine particles using a dispenser.

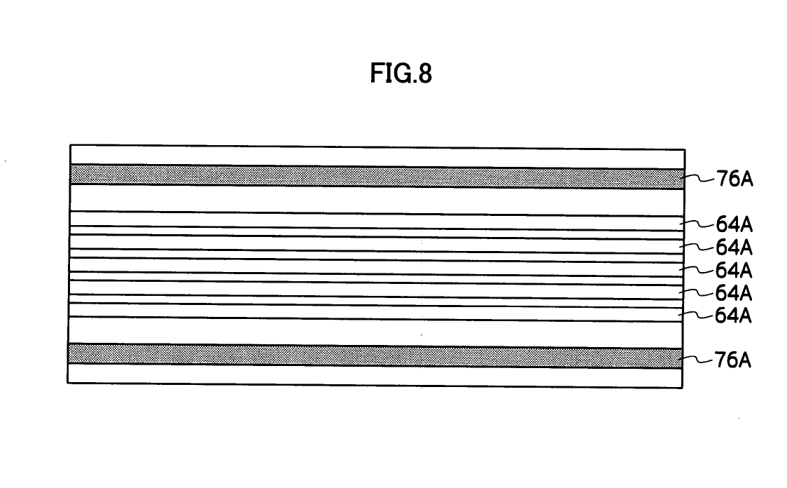

At the next step, as shown in FIG. 6E, the cladding resin layer is cured by UV ray irradiation using the UV ray irradiation device, and the polymer film 76 with electric conductive lines is stuck to the cladding resin layer 66. As a result, the optical waveguide shown in FIG. 8 can be manufactured.

The double-layered polymer film 68 is, therefore, formed without using a substrate, and the inexpensive optical waveguide having the electric conductive lines 76A for power supply can be manufactured by the inexpensive double-layered polymer film 68 and the polymer film 76 with electric conductive lines.

In the manufacturing method according to the fourth exemplary embodiment, the polymer film 62 to be the cladding layer is fixed to the fixing table, and the polymer resin to be the core layer 64 with higher refractive index than the polymer film 62 is applied to the polymer film 62 and is cured, so that the double-layered polymer film 68 is manufactured. Instead of this method, however, the polymer film to be the core layer 14 is fixed to the fixing table, and polymer resin to be a cladding layer with lower refractive index is applied to the core layer and is cured. In such a manner, the double-layered polymer film may be manufactured. In this case, when the double-layered polymer film is manufactured, the core layer is provided to the lower side. For this reason, the double-layered film is turned upside down so that the core layer is arranged on the upper side, and it should be cut by the dicing saw. In this case, for example, an alicyclic olefin film whose refractive index is 1.51 may be used as the core layer, and a fluorinated acrylic resin with low refractive index may be used as the cladding layer.

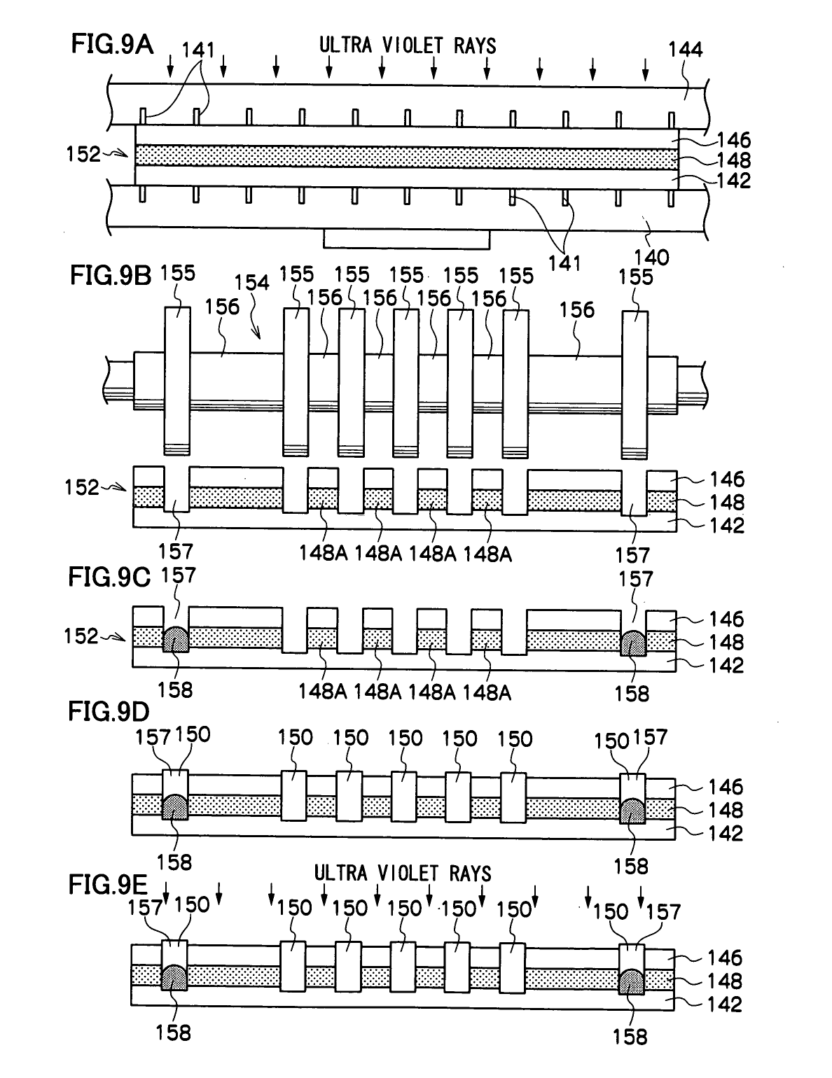

An optical waveguide manufacturing method according to a fifth exemplary embodiment of the invention is explained below following the steps with reference to FIGS. 9A to 9E.

As shown in FIG. 9A, a plurality of adsorption ports 141 are formed on a fixing table 140 and the surface of another fixing table 144, and a suction force is generated by a vacuum pump. A first polymer film 142 to be a first cladding layer is adsorbed and stuck to the fixing table 140, so as to be fixed. A second polymer film 146 to be a second cladding layer which is the same material as the first polymer film 142 is adsorbed and stuck to the fixing table 144 so as to be fixed. Further, an ultraviolet curing polymer resin with higher refractive index than the first polymer film 142 is applied to the first polymer film 142, and the second polymer film 146 is overlapped with it and is irradiated with an UV ray by the UV ray irradiation device so as to be cured. As a result, a core layer 148 is formed, and a triple-layered polymer film 152 is manufactured.

At the next step, as shown in FIG. 9B, the second polymer film 146 and the core layer 148 are cut by the dicing saw having the multi-blade 154.

The multi-blade 154 is composed of two kinds of blades with different outer diameters, and blades 156 with small outer diameter are provided between blades 155 with large outer diameter, respectively.

When the core layer 148 is cut by the multi-blade 154, it is divided by the blades 155 with large outer diameter, and the core portions 148A of the plurality of optical waveguide are processed. Further, simultaneously with the processing of the core portions 148A, the core layer 148 is cut by the blades 155 with large outer diameter, and disposing portions 157 for disposing electric conductive lines for power supply are processed at both ends of the core layer 148, respectively, so as to sandwich the core portions 148A.

At the next step, as shown in FIG. 9C, an electric conductive member is adhered to the disposing portion 157 so that electric conductive line 158 for power supply are disposed. For example, the electric conductive lines 158 can be made of a material containing at least one kind selected from copper, iron, nickel, gold, aluminum, silver and their alloy. Further, the electric conductive lines 158 can be manufactured by applying paste containing silver fine particles using a dispenser. The diameter of the electric conductive lines 158 can be smaller than the diameter of the core portions 148A and can fall within a range of 3 μm to 200 μm.

At the next step, as shown in FIG. 9D, concave portions of the triple-layered polymer film cut by the dicing saw and the disposing portions 157 are filled with ultraviolet curing polymer resin having the same refractive index as the first cladding layer by the spin-coating method. In such a manner, a cladding resin layer 150 is formed.

At the next step, as shown in FIG. 9E, the cladding resin layer 150 is cured by UV ray irradiation using the black light.

The triple-layered polymer film 152 is, therefore, formed without using a substrate, and the inexpensive optical waveguide having the electric conductive line 158 for power supply can be manufactured by the inexpensive triple-layered polymer film 152.

In the manufacturing method according to the fifth exemplary embodiment, the first polymer film 142 to be the first cladding layer and the second polymer film 146 to be the second cladding layer are fixed to the fixing table 140 and the fixing table 144, respectively. Further, the UV curing polymer resin with higher refractive index than the first polymer film 142 is uniformly applied to the first polymer film 142. The second polymer film 146 is overlapped with the first polymer film 142 and is irradiated with an UV ray so as to be cured. As a result, the core layer 148 is formed, and the triple-layered polymer film 152 is manufactured. Instead of this, however, the UV curing polymer resin to be the cladding layer with lower refractive index than the core layer is uniformly applied to both the surfaces of the polymer film to be the core layer and is irradiated with an UV ray so as to be cured. In such a manner, the triple-layered polymer film may be manufactured.

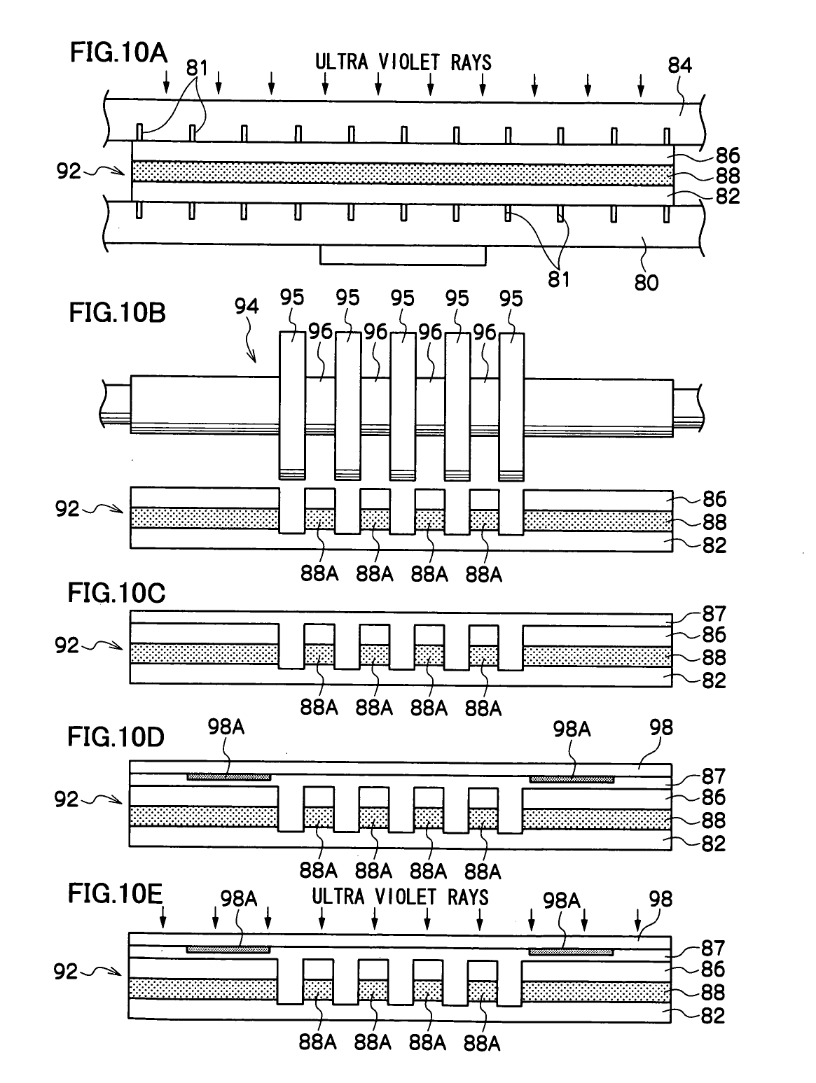

An optical waveguide manufacturing method according to a sixth exemplary embodiment of the present invention is explained below following the steps with reference to FIGS. 10A to 10E.

As shown in FIG. 10A, a plurality of adsorption ports 81 are formed on a fixing table 80 and another fixing table 84, and a suction force is generated by a vacuum pump. A first polymer film 82 to be a first cladding layer is adsorbed to and stuck to the fixing table 80, so as to be fixed. A second polymer film 86 to be a second cladding layer which is the same material as the first polymer film 82 is adsorbed and stuck to the fixing table 84 so as to be fixed. Further, an ultraviolet curing polymer resin with higher refractive index than the first polymer film 82 is applied to the first polymer film 82, and the second polymer film 86 is overlapped with it and is irradiated with an UV ray by the UV ray irradiation device so as to be cured. As a result, a core layer 88 is formed, and a triple-layered polymer film 92 is manufactured.

At the next step, as shown in FIG. 10B, the second polymer film 86 and the core layer 88 are cut by the dicing saw having the multi-blade 94.

The multi-blade 94 is composed of two kinds of blades with different outer diameters, and blades 96 with small outer diameter are provided between blades 95 with large outer diameter, respectively.

The core layer 88 is cut by the multi-blade 94 and is divided by the blades 95 with large outer diameter, so that a plurality of core portions 88A of the optical waveguide are processed.

At the next step, as shown in FIG. 10C, concave portions of the cut triple-layered polymer film 92 are filled with ultraviolet curing polymer resin having the same refractive index as the first cladding layer by the spin-coating method, and the second polymer film 86 is covered with the polymer resin. In such a manner, a cladding resin layer 87 is formed.

At the next step, as shown in FIG. 10D, a pair of electric conductive lines 98A for power supply are provided to the cladding resin layer 87, and a polymer film 98 with electric conductive lines whose refractive index is the same as the cladding layer is laminated to the cladding resin layer 87. For example, the electric conductive lines 98A can be made of a material containing at least one kind selected from a copper, iron, nickel, gold, aluminum, silver and their alloy. Further, the electric conductive lines 98A can be manufactured by applying paste containing silver fine particles using a dispenser.

At the next step, as shown in FIG. 10E, the cladding resin layer 87 is cured by UV ray irradiation using the UV ray irradiation device, and the polymer film 98 with electric conductive lines is stuck to the cladding resin layer 87.

The triple-layered polymer film 92 is, therefore, formed without using a substrate, and the inexpensive optical waveguide having the electric conductive lines 98A for power supply can be manufactured by the inexpensive triple-layered polymer film 92 and the polymer film 98 with electric conductive lines.

In the manufacturing method according to the sixth exemplary embodiment, the first polymer film 82 to be the first cladding layer and the second polymer film 86 to be the second cladding layer are fixed to the fixing table 80 and the fixing table 84, respectively. The ultraviolet curing polymer resin with higher refractive index than the first polymer film 82 is uniformly applied to the first polymer film 82. The second polymer film 86 is overlapped with the first polymer film 82 and is irradiated with an UV ray so as to be cured. As a result, a core layer 88 is formed, and the triple-layered polymer film 92 is manufactured. Instead of this method, however, an UV curing polymer resin to be the cladding layer whose refractive index is lower than the core layer is uniformly applied to both the surfaces of the polymer film to be the core layer, and is irradiated with an UV ray so as to be cured. In such a manner, the triple-layered polymer film may be manufactured.

### EXAMPLES

The examples are explained below more concretely, but the invention is not limited to these examples.

### Example 1

According to the manufacturing method of the first exemplary embodiment, an epoxy film (thickness: 50 μm, refractive index: 1.60) to be the core layer having high refractive index is adsorbed and stuck to the table. An acrylic UV curing resin to be the cladding layer with refractive index of 1.51 is applied with thickness of 25 μm to the epoxy film, and is irradiated with an UV ray to be cured. In such a manner, a double-layered polymer film is manufactured.

The double-polymer film is cut by a dicing saw with multi-wheel blade with accuracy of 55±5 μm from the core layer side. At this time, multi-blade, in which the blades with large outer diameter with thickness of 50 μm and blades with small outer diameter with thickness of 200 μm are combined alternately, is used.

An acrylic UV curing resin with refractive index of 1.51 is applied to the upper portion of the core layer into thickness of 25 μm, and is irradiated with an UV ray so as to be cured.

Finally, the double layered polymer film is diced by a normal blade, so that an optical waveguide is manufactured.

As a result, the inexpensive optical waveguide having a plurality of core portions in which the width of the core portions is 50 μm and a pitch is 250 μm can be manufactured by one-time cutting.

### Example 2

According to the manufacturing method of the first exemplary embodiment, an arton film to be the cladding layer (made by JSR, thickness: 25 μm, refractive index: 1.51) is adsorbed to be stuck to the table. An acrylic UV curing resin with refractive index of 1.59 is applied to the film into a thickness of 50 μm, and is irradiated with an UV ray so as to be cured. In such a manner, a double-layered polymer film is manufactured.

The double-layered polymer film is cut by a dicing saw with a multi-wheel blade with accuracy of 55±5 μm from the core layer side. At this time, the multi-blade, in which blades having large outer diameter and thickness of 50 μm, and blades having small outer diameter and thickness of 200 μm are combined alternately, is used.

An acrylic UV curing resin with refractive index of 1.51 is applied to the upper portion of the cut core layer into a thickness of 25 μm, and is irradiated with an UV ray so as to be cured.

Finally, the double-layered polymer film is diced by using a normal blade, so that an optical waveguide is manufactured.

As a result, the inexpensive optical waveguide, which has a plurality of core portions with width of 50 μm and with pitch of 250 μm, can be manufactured by one-time cutting.

### Example 3

According to the manufacturing method of the second exemplary embodiment, an epoxy film with high refractive index (thickness of 50 μm, refractive index: 1.60) to be the core layer is used. An acrylic UV curing resin with refractive index of 1.51 is uniformly applied to both surfaces of the core layer into a thickness of 20 μm. The acrylic UV curing resin is irradiated with an UV ray so as to be cured. In such a manner, a triple-layered polymer film is manufactured.

The triple-layered polymer film is cut by a dicing saw with a multi-wheel blade with accuracy of 75±5 μm. At this time, a multi-blade, in which blades with large outer diameter and thickness of 50 μand blades with small outer diameter and thickness of 200 μm are combined alternately, is used.

An acrylic UV curing resin with refractive index of 1.51 is applied to fill the concave portions, and is irradiated with an UV ray so as to be cured.

Finally, the triple-layered polymer film is diced by using a normal blade, so that an optical waveguide is manufactured.

As a result, the inexpensive optical waveguide, which has a plurality of core portions with width of 50 μm and with pitch of 250 μm, can be manufactured by one-time cutting.

### Example 4

According to the manufacturing method of the first exemplary embodiment, a fluorinated polyimide film to be the cladding layer (thickness of 20 μm, refractive index: 1.55) is adsorbed to be stuck to the table. An epoxy UV curing resin with refractive index of 1.62 is applied to the film into a thickness of 50 μm. The epoxy UV curing resin is irradiated with an UV ray so as to be cured. In such a manner, a double-layered polymer film is manufactured.

The double-layered polymer film is cut by a dicing saw with a multi-wheel blade with accuracy of 55±5 μm from the core layer side. At this time, the multi-blade, in which blades having large outer diameter and thickness of 50 μm, and blades having small outer diameter and thickness of 200 μm are combined alternately, is used.

A fluorinated polyamic acid whose refractive index becomes 1.55 after curing is applied to the upper portion of the cut core layer into a thickness of 10 μm, and is heated to be cured at 250° C. As a result, a polyimide film is formed.

Finally, the double-layered polymer film is diced by using a normal blade, so that an optical waveguide is manufactured.

As a result, the inexpensive optical waveguide, which has a plurality of core portions with width of 50 μm and with pitch of 250 μm, can be manufactured by one-time cutting.

### Example 5

According to the manufacturing method of the first exemplary embodiment, a heat-resistance olefin film to be the core layer (thickness: 50 μm, refractive index: 1.62, Tg: 280° C.) is adsorbed to be stuck to the table. An epoxy UV curing resin with refractive index of 1.55 is applied to the olefin film into a thickness of 20 μm, and is irradiated with an UV ray so as to be cured. Further, the epoxy UV curing resin is heated to 200° C. so as to be sufficiently cured. As a result, a double-layered polymer film with flexibility is manufactured.

The double-layered polymer film is cut by a dicing saw with a multi-wheel blade with accuracy of 55±5 μm from the core layer side. At this time, the multi-blade, in which blades having large outer diameter with thickness of 50 μm and blades having small outer diameter with thickness of 200 μm are combined alternately, is used.

An epoxy UV curing resin with refractive index of 1.55 is applied to the double-layered polymer film into a thickness of 20 μm, and is irradiated with an UV ray so as to be cured. The epoxy UV curing resin is further heated to 200° C. so as to be cured sufficiently. As a result, flexibility is obtained.

Finally, the double-layered polymer film is diced by using a normal blade, so that an optical waveguide is manufactured.

As a result, the inexpensive optical waveguide, which has a plurality of core portions with width of 50 μm and with pitch of 250 μm, can be manufactured by one-time cutting.

### Example 6

According to the manufacturing method of the first and second exemplary embodiments, an alicyclic acryl film with small volume contraction and high transparency is used as the polymer film to be the cladding layer. A high-performance optical waveguide in which deformation is less at the time of processing can be manufactured.

### Example 7

According to the manufacturing method of the first and second exemplary embodiments, an alicyclic olefin film with small volume contraction and high transparency is used as the polymer film to be the cladding layer. A high-performance optical waveguide in which deformation is less at the time of processing can be manufactured.

### Example 8

According to the manufacturing method of the first and second exemplary embodiments, an UV curing acrylic resin with small volume contraction is used as the polymer resin to be the core layer. A high-performance optical waveguide in which deformation is less at the time of processing can be manufactured.

### Example 9

According to the manufacturing method of the first and second exemplary embodiments, an UV curing acrylic resin with small volume contraction is used as the polymer resin to be the core layer. A high-performance optical waveguide in which deformation is less at the time of processing can be manufactured.

### Example 10

According to the manufacturing method of the first exemplary embodiment, an UV curing epoxy resin with small volume contraction is used as the polymer resin to be the cladding layer. A high-performance optical waveguide in which deformation is less at the time of processing can be manufactured.

### Example 11

According to the manufacturing method of the first exemplary embodiment, an UV curing acrylic resin with small volume contraction is used as the polymer resin to be the cladding layer. A high-performance optical waveguide in which deformation is less at the time of processing can be manufactured.

### Example 12

According to the manufacturing method of the first exemplary embodiment, an alicyclic acryl film with small volume contraction and high transparency is used as the polymer film to be the core layer. A high-performance optical waveguide in which deformation is less at the time of processing can be manufactured.

### Example 13

According to the manufacturing method of the first exemplary embodiment, an alicyclic olefin film with small volume contraction and high transparency is used as the polymer film to be the core layer. A high-performance optical waveguide in which deformation is less at the time of processing can be manufactured.

### Example 14

According to the manufacturing methods of the first and second exemplary embodiment, when the dicing saw with multi-blade is moved to a rotating axis direction, the core layer is processed into the core portions of the optical waveguide by plural steps of cutting. The plural core portions can be processed in a plurality of places.

### Example 15

According to the manufacturing methods of the first and second exemplary embodiment, in the multi-blade, the blades of large outer diameter are arranged with intervals of 10 to 300 μm so as to be assembled. That is, the blades having small outer diameter and thickness of 10 to 300 μm are assembled between the blades of large outer diameter. Since the blades with small outer diameter has a generalized thickness, the plural core portions can be processed by using the inexpensive multi-blade.

### Example 16

According to the manufacturing methods of the first and second exemplary embodiment, in the multi-blade, the gap between the blades with large outer diameter is adjusted by overlapping plural blade with small outer diameter. The distance between the blades with large outer diameter can be adjusted easily without using a spacer.

### Example 17

According to the manufacturing methods of the first and second exemplary embodiment, in the multi-blade, a length, which is obtained by adding the thickness of the blades with large outer diameter and the thickness of the blades with small outer diameter is determined as the pitch of the core portions. The plural core portions can be processed together at once.

### Example 18

According to the manufacturing method of the third exemplary embodiment, an epoxy film with high refractive index (thickness: 50 μm, refractive index: 1.60) to be the core layer is adsorbed to be stuck to the table. An acrylic UV curing resin with refractive index of 1.51 to be the cladding layer is uniformly applied to the core layer into a thickness of 25 μm. The acrylic UV curing resin is irradiated with an UV ray so as to be cured. In such a manner, a double-layered polymer film is manufactured.

The double-layered polymer film is cut by a dicing saw with a multi-wheel blade with accuracy of 55±5 μm from the core layer side, so that a plurality of core portions and two disposing portions are processed. At this time, the multi-blade, in which blades having large outer diameter with thickness of 50 μm and blades having small outer diameter with thickness of 200 μm are combined alternately, is used.

The two disposing portions are filled with silver paste by a dispenser, so that electric conductive lines are disposed.

An acrylic UV curing resin with refractive index of 1.51 is applied to the upper portion of the cut core layer into a thickness of 25 μm, and is irradiated with an UV ray so as to be cured.

Finally, the double layered polymer film is diced by a normal blade, so that an optical waveguide is manufactured.

As a result, the inexpensive optical waveguide, which has a plurality of core portions whose pitch is 250 μm and width is 50 μm and the electric conductive lines, can be manufactured by one-time cutting.

### Example 19

According to the manufacturing method of the third exemplary embodiment, an arton film to be the cladding layer (made by JSR, thickness: 25 μm, refractive index: 1.51) is adsorbed to be stuck to the table. An acrylic UV curing resin with refractive index of 1.59 is applied to the film into a thickness of 50 μm, and is irradiated with an UV ray so as to be cured. In such a manner, a double-layered polymer film is manufactured.

The double-layered polymer film is cut by a dicing saw with a multi-wheel blade with accuracy of 55±5 μm from the core layer side, so that a plurality of core portions and two disposing portions are processed. At this time, the multi-blade, in which blades having large outer diameter and thickness of 50 μm, and blades having small outer diameter and thickness of 200 μm are combined alternately, is used.

Copper lines are constructed on the two disposing portions, respectively, so that electric conductive lines are disposed.

An acrylic UV curing resin with refractive index of 1.51 is applied to the upper portion of the cut core layer into a thickness of 25 μm, and is irradiated with an UV ray so as to be cured.

Finally, the double layered polymer film is diced by a normal blade, so that an optical waveguide is manufactured.

As a result, the inexpensive optical waveguide, which has a plurality of core portions whose pitch is 250 μm and width is 50 μm and the electric conductive lines, can be manufactured by one-time cutting.

### Example 20

According to the manufacturing method of the fifth exemplary embodiment, an epoxy film with high refractive index (thickness of 50 μm, refractive index: 1.60) to be the core layer is used. An acrylic UV curing resin with refractive index of 1.51 is uniformly applied to both surfaces of the core layer into a thickness of 20 μm. The acrylic UV curing resin is irradiated with an UV ray so as to be cured. In such a manner, a triple-layered polymer film is manufactured.

The triple-layered polymer film is cut by a dicing saw having a multi-wheel blade with accuracy of 75±5 μm, so that a plurality of core portions and two disposing portions are processed. At this time, a multi-blade, in which blades having large outer diameter and thickness of 50 μm, and blades having small outer diameter and thickness of 200 μm are combined alternately, is used.

Copper lines are constructed on the two disposing portions, respectively, so that electric conductive lines are disposed.

An acrylic UV curing resin with refractive index of 1.51 is applied so as to fill cut concave portions, and is irradiated with an UV ray so as to be cured.

Finally, the triple-layered polymer film is diced by a normal blade, so that an optical waveguide is manufactured.

As a result, the inexpensive optical waveguide, which has a plurality of core portions whose pitch is 250 μm and width is 50 μm and the electric conductive lines, can be manufactured by one-time cutting.

### Example 21

According to the manufacturing method of the fourth exemplary embodiment, an arton film to be the cladding layer (made by JSR, thickness: 25 μm, refractive index: 1.51) is adsorbed to be stuck to the table. An acrylic UV curing resin with refractive index of 1.59 is applied to the film into a thickness of 50 μm, and is irradiated with an UV ray so as to be cured. In such a manner, a double-layered polymer film is manufactured.

The double-layered polymer film is cut by a dicing saw with a multi-wheel blade with accuracy of 55±5 μm from the core layer side, so that a plurality of core portions are processed. At this time, the multi-blade, in which blades having large outer diameter and thickness of 50 μm, and blades having small outer diameter and thickness of 200 μm are combined alternately, is used.

An acrylic UV curing resin with refractive index of 1.51 is applied to the upper portion of the cut core layer into a thickness of 25 μm.

An arton film (made by JSR, thickness: 25 μm, refractive index: 1.51) on which silver power supply lines are patterned by vacuum evaporation and etching is laminated as a polymer film with electric conductive lines to the applied acrylic UV curing resin. Thereafter, the acrylic UV curing resin is irradiated with an UV ray so as to be cured.

Finally, the double layered polymer film is diced by a normal blade, so that an optical waveguide is manufactured.

As a result, the inexpensive optical waveguide, which has a plurality of core portions whose pitch is 250 μm and width is 50 μm and the electric conductive lines, can be manufactured by one-time cutting.

### Example 22

According to the manufacturing method of the fourth exemplary embodiment, an arton film to be the cladding layer (made by JSR, thickness: 25 μm, refractive index: 1.51) is adsorbed to be stuck to the table. An acrylic UV curing resin with refractive index of 1.59 is applied to the film into a thickness of 50 μm, and is irradiated with an UV ray so as to be cured. In such a manner, a double-layered polymer film is manufactured.

The double-layered polymer film is cut by a dicing saw with a multi-wheel blade with accuracy of 55±5 μm from the core layer side, so that a plurality of core portions are processed. At this time, the multi-blade, in which blades having large outer diameter and thickness of 50 μm, and blades having small outer diameter and thickness of 200 μm are combined alternately, is used.

An acrylic UV curing resin with refractive index of 1.51 is applied to the upper portion of the cut core layer into a thickness of 25 μm.

An arton film (made by JSR, thickness: 25 μm, refractive index: 1.51) on which gold power supply lines are patterned by sputtering and etching is laminated as a polymer film with an electric conductive lines to the applied acrylic UV curing resin. Thereafter, the acrylic UV curing resin is irradiated with an UV ray so as to be cured.

Finally, the double layered polymer film is diced by a normal blade, so that an optical waveguide is manufactured.

As a result, the inexpensive optical waveguide, which has a plurality of core portions whose pitch is 250 μm and width is 50 μm and the electric conductive lines, can be manufactured by one-time cutting.

### Example 23

According to the manufacturing methods of the third to sixth exemplary embodiments, metal paste is applied by a dispenser, so that electric conductive lines for power supply are disposed. Since this is a general method, the electric conductive liens can be disposed inexpensively.

### Example 24

According to the manufacturing methods of the third to sixth exemplary embodiments, an electric conductive member is adhere by a sputtering method, so that electric conductive lines for power supply are disposed. Since a generalized device can be used, the electric conductive lines can be disposed inexpensively.

### Example 25

According to the manufacturing methods of the third to sixth exemplary embodiments, an alicyclic acryl film with small volume contraction and high transparency is used as the polymer film to be the cladding layer. A high-performance optical waveguide in which deformation is less at the time of processing can be manufactured.

### Example 26

According to the manufacturing methods of the third to sixth exemplary embodiments, an alicyclic olefin film with small volume contraction and high transparency is used as the polymer film to be the cladding layer. A high-performance optical waveguide in which deformation is less at the time of processing can be manufactured.

### Example 27

According to the manufacturing methods of the third to sixth exemplary embodiments, an UV curing epoxy resin with small volume contraction is used as the polymer resin to be the core layer. A high-performance optical waveguide in which deformation is less at the time of processing can be manufactured.

### Example 28

According to the manufacturing method of the third to sixth exemplary embodiments, an UV curing acrylic resin with small volume contraction is used as the polymer resin to be the core layer. A high-performance optical waveguide in which deformation is less at the time of processing can be manufactured.

### Example 29

According to the manufacturing methods of the third and fourth exemplary embodiments, an UV curing epoxy resin with small volume contraction is used as the polymer resin to be the cladding layer. A high-performance optical waveguide in which deformation is less at the time of processing can be manufactured.

### Example 30

According to the manufacturing methods of the third and fourth exemplary embodiments, an UV curing acrylic resin with small volume contraction is used as the polymer resin to be the cladding layer. A high-performance optical waveguide in which deformation is less at the time of processing can be manufactured.

### Example 31

According to the manufacturing methods of the third and fourth exemplary embodiments, an alicyclic acryl film with small volume contraction and high transparency is used as the polymer film to be the core layer. A high-performance optical waveguide in which deformation is less at the time of processing can be manufactured.

### Example 32

According to the manufacturing methods of the third and fourth exemplary embodiments, an alicyclic olefin film with small volume contraction and high transparency is used as the polymer film to be the core layer. A high-performance optical waveguide in which deformation is less at the time of processing can be manufactured.

### Example 33

According to the manufacturing method of the third to sixth exemplary embodiments, when the dicing saw with multi-blade is moved to the rotating axis direction, the core layers are processed into core portions of the optical waveguide by plural steps of cutting. The plural core portions can be processed in plural places.

### Example 34

According to the manufacturing methods of the third to sixth exemplary embodiments, in the multi-blade, the blades of large outer diameter are arranged with an interval of 10 to 300 μm so as to be assembled. That is, the blades having small outer diameter and thickness of 10 to 300 μm are assembled between the blades of large outer diameter. Since the blades with small outer diameter has a generalized thickness, the plural core portions can be processed by using the inexpensive multi-blade.

### Example 35

According to the manufacturing methods of the third to sixth exemplary embodiments, in the multi-blade, the gap between the blades with large outer diameter is adjusted by overlapping the plural blades with small outer diameter. The distance between the blades with large outer diameter can be adjusted easily without using a spacer.

### Example 36

According to the manufacturing methods of the third to sixth exemplary embodiments, in the multi-blade, a length, which is obtained by adding the thickness of the blades with large outer diameter and the thickness of the blades with small outer diameter is determined as the pitch of the core portions. The plural core portions can be processed together at once.

What is claimed is:

1. An optical waveguide manufacturing method, comprising:
(a) preparing a polymer film fixing table, applying a first polymer resin with a refractive index different from the polymer film to the polymer film and curing the resin, manufacturing a double-layered polymer film having a cladding layer and a core layer with a refractive index higher than the cladding layer;
(b) cutting the core layer using a dicing saw equipped with a blade capable of cutting the resin layer processing the core layer into core portions of an optical waveguide; and
(c) filling recessed portions of the cut core layer with a second polymer resin with the same refractive index as the cladding layer, covering the core portions with the second polymer resin, and curing the second polymer resin to form a cladding resin layer.

2. The optical waveguide manufacturing method of claim 1, wherein the double-layered polymer film is manufactured by preparing a polymer film to be the core layer, applying a polymer resin with a lower refractive index than that of the core layer onto the core layer to be the cladding layer, and curing the applied polymer resin.

3. The optical waveguide manufacturing method of claim 1, wherein the double-layered polymer film is manufactured by preparing a polymer film to be the cladding layer of the optical waveguide, applying a polymer resin with a higher refractive index than the cladding layer onto the cladding layer to be the core layer, and curing the polymer resin.

4. The optical waveguide manufacturing method of claim 2, wherein the polymer resin for the cladding layer is an ultraviolet curing resin.

5. The optical waveguide manufacturing method of claim 3, wherein the polymer film for the cladding layer is an alicyclic film.

6. The optical waveguide manufacturing method of claim 3, wherein the polymer resin for the core layer is an ultraviolet curing resin.

7. The optical waveguide manufacturing method of claim 2, wherein the polymer film for the core layer is an alicyclic film.

8. The optical waveguide manufacturing method of claim 1, wherein the core layer is processed into the core portions of the optical waveguide by the cutting of the dicing saw of a multi-blade composition of two kinds of blades with different outer diameters, obtained by providing blades with a small outer diameter between blades with a large outer diameter.

9. The optical waveguide manufacturing method of claim 8, wherein the blades with the small outer diameter of the multi-blade cut a surface of the core portions.

10. The optical waveguide manufacturing method of claim 8, wherein when the dicing saw having the multi-blade is moved in a rotating axis direction, the core layer is processed into the core portions of the optical waveguide by a plurality times of cutting.

11. The optical waveguide manufacturing method of claim 8, wherein in the multi-blade, the blades with the large outer diameter are assembled with a spacing of 10 to 300 μm.

12. The optical waveguide manufacturing method of claim 1, wherein
at (b), the core layer is cut by the dicing saw equipped with the blade capable of cutting the resin layer so that the core portions of the optical waveguide and disposing portions of electric conductive lines for power supply are respectively processed, and the electric conductive lines are disposed on the disposing portions,
at (c), the disposing portions as well as the recessed portions of the cut core layer are filled with the second polymer resin having the same refractive index as the cladding layer.

13. The optical waveguide manufacturing method of claim 12, wherein the electric conductive lines for power supply are disposed by application of a metal paste.

14. The optical waveguide manufacturing method of claim 12, wherein an electrically conductive member is caused to adhere by a sputtering method, forming the electric conductive lines for power supply.

15. The optical waveguide manufacturing method of claim 1, wherein
at (c), recessed portions of the cut core layer are filled with a second polymer resin having the same refractive index as the cladding layer, and the core portions are covered with the filling polymer resin,
a polymer film having electric conductive lines for power supply whose refractive index is the same as the cladding layer and is laminated to the cladding resin layer,
the cladding resin layer is cured, and the polymer film with electric conductive lines is adhered to the cladding resin layer.

16. The optical waveguide manufacturing method of claim 15, wherein the electric conductive lines for power supply are disposed by application of a metal paste.

17. The optical waveguide manufacturing method of claim 15, wherein an electric conductive member is caused to adhere by a sputtering method, so that the electric conductive lines for power supply are formed.

18. An optical waveguide manufacturing method, comprising:
(a) preparing a first polymer film onto a fixing table to be a first cladding layer, preparing a second polymer film layer whose material is the same as the first cladding layer onto another fixing table to be a second cladding, applying a first polymer resin as a core layer having a refractive index higher than the first cladding layer between the first polymer film and the second polymer film, and curing the first polymer resin to manufacture a triple-layered polymer film;
(b) cutting the second cladding layer and the core layer using a dicing saw equipped with a blade capable of cutting the resin layer processing the core layer into core portions of an optical waveguide; and
(c) filling recessed portions of the cut triple-layered polymer film with a second polymer resin having the same refractive index as the first cladding layer and curing the second polymer resin so as to form a cladding resin layer.

19. The optical waveguide manufacturing method of claim 18, wherein the polymer films to be the first cladding layer and the second cladding layer are alicyclic acrylic films.

20. The optical waveguide manufacturing method of claim 18, wherein the polymer resin to be the core layer is an ultraviolet curing resin.

21. The optical waveguide manufacturing method of claim 18, wherein the core layer is processed into the core portions of the optical waveguide by the cutting of the dicing saw of a multi-blade composition of two kinds of blades with different outer diameters obtained by providing blades with a small outer diameter between blades with a large outer diameter.

22. The optical waveguide manufacturing method of claim 21, wherein the blades with the small outer diameter of the multi-blade cut a surface of the core portions.

23. The optical waveguide manufacturing method of claim 21, wherein when the dicing saw having the multi-blade is moved in a rotating axis direction, the core layer is processed into the core portions of the optical waveguide by a plurality of times of cutting.

24. The optical waveguide manufacturing method of claim 21, wherein in the multi-blade, the blades with the large outer diameter are assembled with a spacing of 10 to 300 μm.

25. The optical waveguide manufacturing method of claim 18, wherein
at (b), the second cladding layer and the core layer are cut by the dicing saw equipped with a blade capable of cutting the resin layer, and the core portions of the optical waveguide as well as disposing portions of electric conductive lines for power supply are respectively processed, and the electric conductive lines are disposed on the disposing portions,
at (c), the disposing portions as well as the recessed portions of the cut triple-layered polymer film are filled with a polymer resin having the same refractive index as the first cladding layer.

26. The optical waveguide manufacturing method of claim 25, wherein the electric conductive lines for power supply are formed by application of a metal paste.

27. The optical waveguide manufacturing method of claim 25, wherein an electrically conductive member is caused to adhere by a sputtering method, forming the electric conductive lines for power supply.

28. The optical waveguide manufacturing method of claim 18, wherein
at (c), recessed portions of the cut triple-layered polymer film are filled with a second polymer resin having the same refractive index as the first cladding layer,
the second cladding layer is covered with the second polymer resin having the same refractive index as the first cladding layer,
a polymer film having electric conductive lines for power supply whose refractive index is the same as the first cladding layer is laminated to the cladding resin layer,
the cladding resin layer is cured, and the polymer film with electric conductive lines is adhered to the cladding resin layer.

29. The optical waveguide manufacturing method of claim 28, wherein the electric conductive lines for power supply are disposed by application of a metal paste.

30. The optical waveguide manufacturing method of claim 28, wherein an electrically conductive member is caused to adhere by a sputtering method, forming the electric conductive lines for power supply.

31. An optical waveguide manufactured by a manufacturing method, the manufacturing method comprising:
(a) preparing a polymer film, applying a first polymer resin with refractive index different from the polymer film to the polymer film, and curing the resin manufacturing a double-layered polymer film having a cladding layer and a core layer with a refractive index higher than the cladding layer;
(b) cutting the core layer using a dicing saw equipped with a blade capable of cutting the resin layer processing the core layer into core portions of an optical waveguide; and
(c) filling recessed portions of the cut core layer with a second polymer resin having the same refractive index as the cladding layer, covering the core portions with the second polymer resin, and curing the second polymer resin so as to form a cladding resin layer.

32. The optical waveguide of claim 31, wherein, in the manufacturing method,
at (b), the core layer is cut by the dicing saw equipped with the blade capable of cutting the resin layer, the core portions of the waveguide and disposing portions of electric conductive lines for power supply are processed, and the electric conductive lines are disposed on the disposing portions, and
at (c), the disposing portions as well as the cut recessed portions of the cut core layer are filled with the second polymer resin having the same refractive index as the cladding layer.

33. An optical waveguide manufactured by a manufacturing method, the manufacturing method comprising:
(a) preparing a first polymer film to be a first cladding layer, fixing a second polymer film whose material is the same as the first cladding layer to another to be a second cladding layer, applying a first polymer resin as a core layer having a refractive index higher than the first cladding layer between the first polymer film and the second polymer film, and curing the first polymer resin so as to manufacture a triple-layered polymer film;
(b) cutting the second cladding layer and the core layer using a dicing saw equipped with a blade capable of cutting the resin layer processing the core layer into core portions of an optical waveguide; and
(c) filling recessed portions of the cut triple-layered polymer film with a second polymer resin having the same refractive index as the first cladding layer and curing the second polymer resin so as to form a cladding resin layer.

34. The optical waveguide of claim 33, wherein, in the manufacturing method,
at (b), the second cladding layer and the core layer are cut by the dicing saw equipped with the blade capable of cutting the resin layer, and the core portions of the optical waveguide and disposing portions of electric conductive lines for power supply are respectively processed, and the electric conductive lines are disposed on the disposing portions,
at (c), the disposing portions as well as the concave portions of the cut triple-layered polymer film are filled with the second polymer resin having the same refractive index as the first cladding layer.
